(19) United States
(12) Patent Application Publication
(10) Pub. No.: US 2018/0104917 A1
(43) Pub. Date: Apr. 19, 2018

(54) METHOD OF MANUFACTURING A COMPOSITE ARTICLE

(71) Applicant: GM GLOBAL TECHNOLOGY OPERATIONS LLC, DETROIT, MI (US)

(72) Inventor: Xiaoling Jin, Farmington Hills, MI (US)

(21) Appl. No.: 15/297,255

(22) Filed: Oct. 19, 2016

(51) Int. Cl. B29C 70/44; B29C 67/00; B29C 35/02; B33Y 10/00; B33Y 40/00; B33Y 70/00; B33Y 50/02

(52) U.S. Cl. CPC B29C 70/443; B29C 67/0088; B29C 35/02; B29K 2063/00; B33Y 40/00; B33Y 70/00; B33Y 50/02; B33Y 10/00

(57) ABSTRACT

A method for creating a composite article using fast heat treating thermoset resin materials for 3D printing articles, including articles of complex geometry. The method includes using vacuum impregnation and subsequent heat treating as post printing processes to further strengthen and enhance the functionality of the article.

### FIELD

Apparatuses consistent with exemplary embodiments relate to a method for manufacturing an article. More particularly, apparatuses consistent with an exemplary embodiment relate to a method for 3 dimensional (3D) printing/additive manufacturing of a composite article with introduction of post-printing impregnation to strengthen the article.

### BACKGROUND

The statements in this section merely provide background information related to the present disclosure and may or may not constitute prior art.

In the prototyping sector of product development, 3D printing is lauded as being a fast, efficient means of creating parts before the parts go into the manufacturing stage of development.

While 3D printing is a viable technology in terms of testing parts for form and fit to make sure that no design and engineering tweaks are necessary before any product is green-lighted for production, there are disadvantages in using the technology as well.

These range from a limited use of materials to create parts from to concerns over whether the physical properties of the parts will provide useful information relative to its functionality in development.

In conventional 3D printing, the material of choice is a thermoplastic resin as it can be deposited down in molten layers to form the final part. However, a part created from thermoplastic resin material have a tendency to have micro pores and significant anisotropies which limit the part's functionality. Due to severe limitations of thermoplastic materials' post printing processibility, such functional deficiency of the printed part is hard to correct. It would be useful to development simpler tools or processes to correct such functional deficiencies.

### SUMMARY

One or more exemplary embodiments address the above issue by providing a method for manufacturing an article. More particularly, apparatuses consistent with exemplary embodiments relate to a method for three dimensional (3D) printing of a composite article with post-printing impregnation using a thermoset resin.

According to an aspect of an exemplary embodiment, a method of creating a composite article includes creating a three dimensional (3D) virtual model of the article. Another aspect of the exemplary embodiment includes dividing the virtual model into a plurality of contiguous two dimensional layers. Still another aspect as according to the exemplary embodiment includes loading the divided virtual model into a three dimensional printing device that is operable to create a three dimensional article made from a thermoset polymer resin material. Another aspect of the exemplary embodiment includes loading the divided virtual model into a three dimensional printing device that is operable to create a three dimensional article made from a thermoplastic polymer resin.

And further aspects of the exemplary embodiment include impregnating the three dimensional article with a reinforcing thermoset material and heat treating the impregnated 3D article for a determinate period of time.

In accordance with other aspects of the exemplary embodiment, wherein the thermoset polymer resin material is an epoxy resin. Still in accordance with aspects of the exemplary embodiment, wherein the thermoset polymer resin is a phenolic resin. And another aspect of the exemplary embodiment wherein the epoxy or phenolic resin systems includes using at least one reinforcing filler material.

Yet further aspects of the exemplary embodiment wherein the thermoset polymer resin is an unsaturated polyester based resin system. And another aspect of the exemplary embodiment wherein the unsaturated polyester based resin system includes using at least one reinforcing filler material. Still another aspect of the exemplary embodiment wherein the reinforcing filler material is glass fiber.

According to another aspect of the exemplary embodiment wherein impregnating the three dimensional article further comprises using a liquid thermoset resin having curatives. And another aspect wherein impregnating the three dimensional article is accomplished with a vacuum impregnation process. Still further aspects of the exemplary embodiment wherein impregnating the three dimensional article is accomplished with a pressurized impregnation process.

According to still another aspect of the exemplary embodiment wherein the liquid thermoset resin is an epoxy resin. And another aspect of the exemplary embodiment wherein the liquid thermoset resin is phenolic resin. Yet another aspect in accordance with the exemplary embodiment wherein the liquid thermoset resin is an unsaturated polyester based resin system.

Another aspect in accordance with the exemplary method wherein the liquid thermoset resin include at least one reinforcing filler material. Yet another aspect of the exemplary embodiment wherein heat treating the impregnated article further comprises heat treating the impregnated three dimensional article. And still another aspect of the exemplary embodiment wherein heat treating conditions are dependent on article size and resin material used to create it.

### BRIEF DESCRIPTION OF THE DRAWINGS

The present exemplary embodiment will be better understood from the description as set forth hereinafter, with reference to the accompanying drawings, in which:

FIG. 1 is an illustration of an article of manufacture created using 3D printing processes in accordance with an exemplary embodiment;

FIG. 1a is an illustration of an enlarged view of a subsection of the article created using 3D printing in accordance with the exemplary embodiment;

FIG. 2 is an illustration of an exploded view of a plurality of contiguous layers that form the 3D printed article in accordance with the exemplary embodiment;

FIG. 3 is an illustration of an algorithm of the method for 3D printing of an article using a thermoset resin in accordance with the exemplary embodiment;

FIG. 4 is an illustration of apparatuses used to facilitate the method for 3D printing of an article using a thermoset resin in accordance with an exemplary embodiment; and

FIG. 4a is an illustration of an article created using the method for 3D printing of an article using a thermoset resin in accordance with the exemplary embodiment.

### DETAILED DESCRIPTION OF THE INVENTION

The following description is merely exemplary in nature and is not intended to limit the present disclosure, application, or uses thereof.

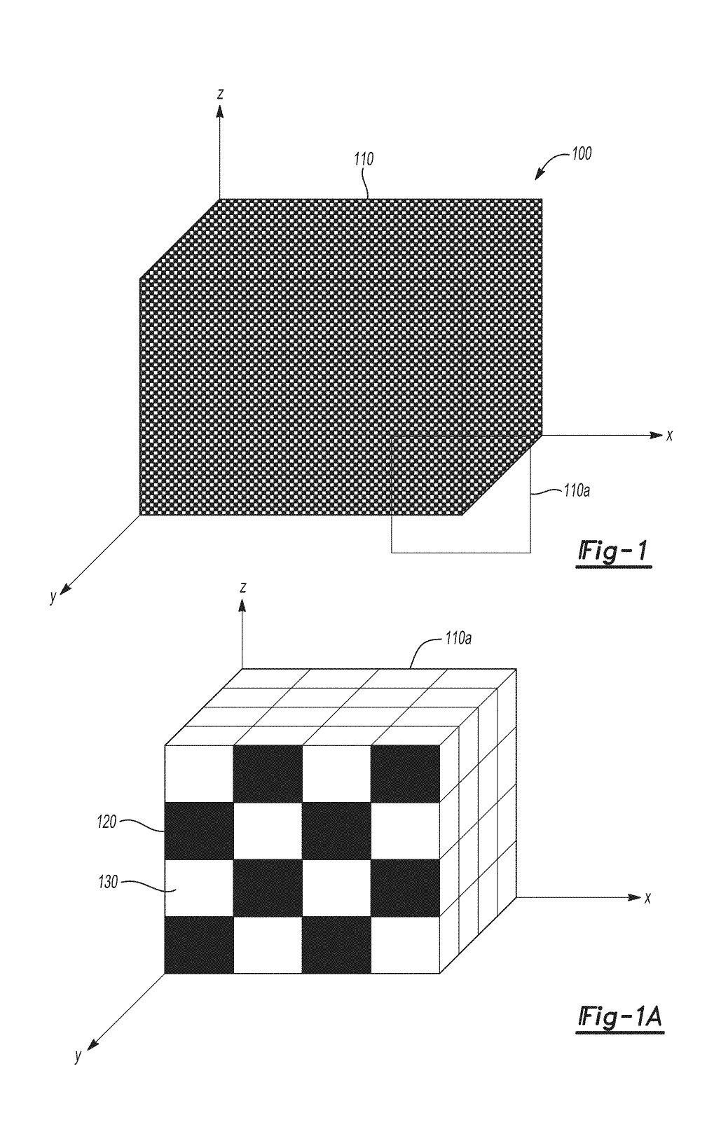

FIG. 1 provides an illustration 100 of an article of manufacture 110 created using a conventional 3D printing process in accordance with an exemplary embodiment wherein 110a is a subsection to be described below. It is appreciated that the article of manufacture 110 presented here as a basic cube is merely for the purpose of explaining the method for 3D printing of an article in accordance with the exemplary embodiment and is not intended to limit the scope with regard to variety or geometric complexity of 3D articles that may be created from its use. In accordance with aspects of the exemplary embodiment, the article is made using a thermoset resin material but may also be made using a thermoplastic resin material when appropriate impregnation and heat treating are employed to the benefit of the article's functionality and structure.

Referring to FIG. 1a, an illustration of an enlarged view of a subsection 110a of the article of FIG. 1 created using 3D printing in accordance with the exemplary embodiment is presented. It is appreciated that the article of manufacture 110 is formed of a plurality of micro-sized ultrafine particles 120 that are bound together via a sintering process to create the 3D article 110 that includes micro-sized spaces 130 between the particles 120 such that the 3D article 110 created is highly porous at a microscopic level. These micro-sized spaces 130 not only make the 3D article 110 permeable to fluids but lessens its structural strength in comparison to a completely solid article of the same form and material.

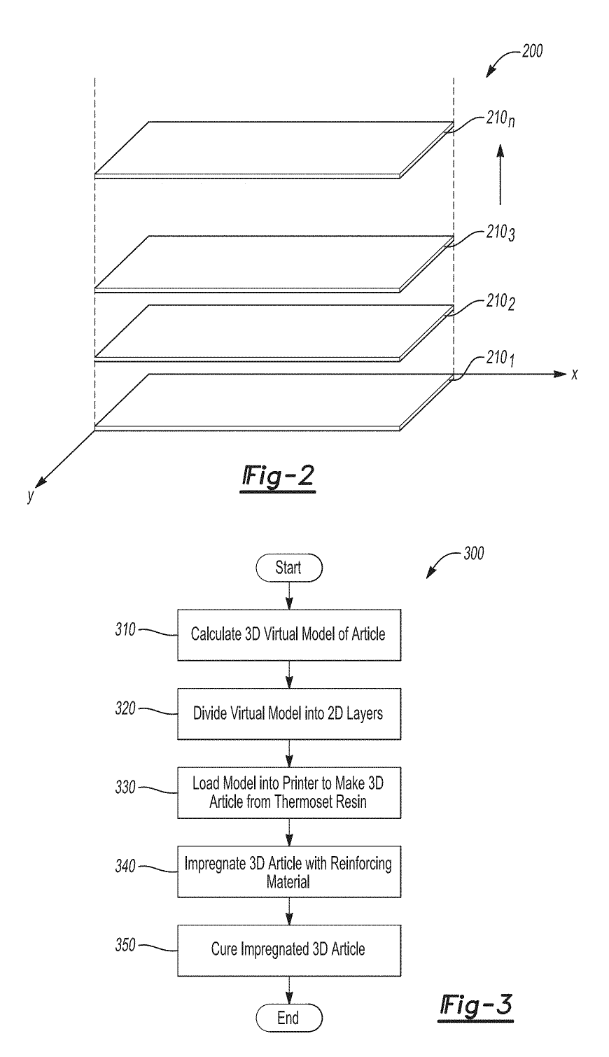

Referring now to FIG. 2, is an illustration of an exploded view 200 of a plurality of contiguous layers 2101, 2102, 2103, through 210n that form the 3D printed article 110 in accordance with the exemplary embodiment is presented. During the 3D printing process, the creation of the 3D article 110 is achieved using additive processes.

In an additive, process, an object is created by laying down the successive contiguous layers 2101, 2102, 2103, through 210n of fast heat treating thermoset resin material until the 3D article 110 is created. Thermoset resin material is far more heat stable than thermoplastic material which permits the use of post printing processes to improve the strength of the 3D article 110.

Each of these contiguous layers 2101, 2102, 2103, through 210n can be seen as a thinly sliced horizontal cross-section of the 3D article, 110. Depending on the 3D article's size, the 3D printer and the materials used, this process could take several minutes to hours or even days to complete.

FIG. 3 is an illustration of an algorithm 300 of the method for 3D printing of an article using a thermoset resin in accordance with the exemplary embodiment. At block 310, the method begins with creating a three dimensional virtual model of the 3D article 110. This virtual model may be created as a computer aided design (CAD), stereo lithography (STL), or a virtual reality modeling language (VRML) file.

At block 320, the method continues with dividing the virtual model into a plurality of contiguous two dimensional layers as illustrated in FIG. 2. Then, at block 330, the method continues by loading the divided virtual model into a three dimensional printing device that is operable to create the 3D article 110 made from a thermoset polymer resin material in accordance with the exemplary embodiment. The thermoset resin materials used to form the 3D article 100 in accordance with the exemplary embodiment include, but are not limited to, epoxy, phenolic or unsaturated polyester based resins systems. A thermoplastic resin material may be when appropriate impregnation and heat treating are employed to the benefit of the article's functionality and structure. It is appreciated that the article may also be made from a thermoplastic resin material when appropriate impregnation and heat treating are employed to the benefit of the article's functionality and structure.

At block 340, the method continues with impregnating the 3D article 110 with a reinforcing material to enhance the versatility and strength of the article. The post print impregnation can use a liquid thermoset resin including epoxy, phenolic, or unsaturated polyester systems with various curatives in accordance with the exemplary embodiment. The impregnation process can be accomplished using a vacuum impregnation or a pressurized impregnation process. It is appreciated that other liquid thermoset resins and impregnation processes may be used for the intended purpose described herein without exceeding the scope of the exemplary embodiment.

At block 350, the method ends with heat treating the impregnated three dimensional article, preferably through a heat treating process. The temperature and time for heat treating the 3D article 110 will be dependent on the size of the article and the material used to form it. The curing/heat treating conditions in accordance with the exemplary embodiment may range between ambient-180° C. Cure time range from approximately 30 minutes several hours.

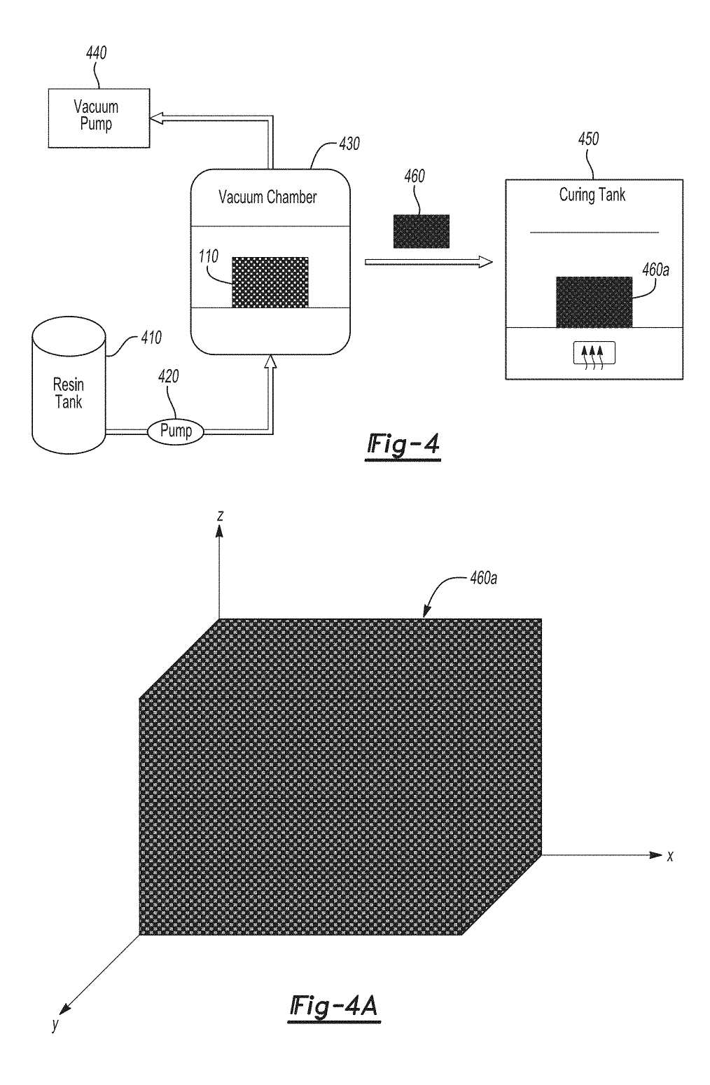

FIG. 4 is an illustration of apparatuses used to facilitate the method for impregnating a 3D printed article using a thermoset resin in accordance with an exemplary embodiment. A resin tank 410 holds the thermoset material that is drawn from the resin tank 410 by a pump 420 into a vacuum impregnation chamber 430. The 3D article 110 is impregnated with the thermoset resin material as air is drawn from the vacuum chamber 430 by a vacuum pump 440. After the impregnation process, the thoroughly impregnated 3D article 460 is placed into a heat treating chamber, such as oven 450 for heat treating under heat treating conditions based on the size and material of the 3D article 460a.

FIG. 4a is an illustration of an article 460a created using the method for 3D printing of an article impregnated with a thermoset resin in accordance with the exemplary embodiment. A 3D article 460a printed with thermoset resin coupled with post printing impregnation and heat treating to create versatile components with more uniform strength and enhanced functionality.

The description of the invention is merely exemplary in nature and variations that do not depart from the gist of the invention are intended to be within the scope of the invention. Such variations are not to be regarded as a departure from the spirit and scope of the invention.

What is claimed is:

1. A method of creating a composite article comprising:
creating a three dimensional virtual model of the article;
dividing the virtual model into a plurality of contiguous two dimensional layers;
loading the divided virtual model into a three dimensional printing device that is operable to create a three dimensional article made from a thermoset polymer resin material;
impregnating the three dimensional article with a reinforcing material; and
heat treating the impregnated three dimensional article.

2. The method of claim 1 wherein the thermoset polymer resin material is an epoxy resin with or without reinforcing fillers.

3. The method of claim 1 wherein the thermoset polymer resin is a phenolic resin with or without reinforcing fillers.

4. The method of claim 1 wherein the thermoset polymer resin is an unsaturated polyester based resin system with or without reinforcing fillers.

5. The method of claim 1 wherein impregnating the three dimensional article further comprises using a liquid thermoset resin having curatives.

6. The method of claim 1 wherein impregnating the three dimensional article is accomplished with a vacuum impregnation process.

7. The method of claim 1 wherein impregnating the three dimensional article is accomplished with a pressurized impregnation process.

8. The method of claim 5 wherein the liquid thermoset resin is an epoxy resin.

9. The method of claim 5 wherein the liquid thermoset resin is phenolic resin.

10. The method of claim 5 wherein the liquid thermoset resin is an unsaturated polyester based resin system.

11. The method of claim 10 wherein the liquid thermoset resin includes at least one reinforcing filler material.

12. The method of claim 1 wherein heat treating the impregnated article further comprises heat treating the impregnated three dimensional article.

13. The method of claim 12 wherein heat treating conditions are dependent on article size and resin material.

14. The method of claim 1 wherein loading further comprises creating a three dimensional article made from a thermoplastic polymer resin material.

15. The method of claim 1 wherein heat treating further comprises heat treating between ambient and 180° C.
